(19) United States
(12) Patent Application Publication
(10) Pub. No.: US 2023/0004458 A1
(43) Pub. Date: Jan. 5, 2023

(54) IDENTIFIERS OF CRASH EVENT WORK ITEMS

(71) Applicant: Hewlett-Packard Development Company, L.P., Spring, TX (US)

(72) Inventors: Christopher Tomas Stewart, Spring, TX (US); Marcus Leo Avery, Spring, TX (US)

(21) Appl. No.: 17/779,105

(22) PCT Filed: Nov. 25, 2019
(86) PCT No.: PCT/US2019/063062

§ 371 Date: May 23, 2022

(51) Int. Cl. G06F 11/07

(52) U.S. Cl. CPC G06F 11/0769; G06F 11/0775; G06F 11/0721

(57) ABSTRACT

In some examples, a system comprises a network interface; a storage device comprising machine-readable instructions; and a processor coupled to the network interface, the processor to access the storage device, wherein execution of the machine-readable instructions causes the processor to: collect crash event data; categorize the crash event data by an application executing when the crash event occurred; identify a crash event corresponding to the crash event data; create an identifier for the crash event; compare the identifier of the crash event to a list of work items, wherein each work item has an identifier; and update the list of work items based on the comparison.

### BACKGROUND

Event data is information pertaining to the daily operations of hardware components and applications of a computing device. When an application of the computing device fails (e.g., crashes), the application may generate event data pertaining to the crash event (e.g., crash event data). Crash event data may include information usable for diagnosing and analyzing the failure to determine a root cause of the failure. Based on the diagnosis and analysis, the application may be modified to prevent future occurrences of the crash event.

### BRIEF DESCRIPTION OF THE DRAWINGS

Various examples will be described below referring to the following figures:

FIG. 1 depicts a schematic diagram of a system in accordance with various examples;

FIG. 2 depicts a schematic diagram of a processing environment of a system in accordance with various examples;

FIG. 3 depicts a schematic diagram of a processing environment of a system in accordance with various examples;

FIG. 4 depicts a schematic diagram of a processing environment of a system in accordance with various examples;

FIG. 5 depicts a schematic diagram of a system in accordance with various examples;

FIG. 6 depicts a schematic diagram of a system in accordance with various examples;

FIG. 7 depicts a flow diagram of a method in accordance with various examples; and

FIG. 8 depicts a flow diagram of a method in accordance with various examples.

### DETAILED DESCRIPTION

As explained above, an application (e.g., machine-readable instructions) of a computing device (e.g., laptop, notebook, tablet, smartphone, mobile device, or some other electronic device with an ability to capture data about operations of the device) may crash. For example, if an application attempts to utilize more memory than the computing device has available, the application may freeze operations of the computing device, close down in a disruptive manner, or cease to respond to user commands. The crash event may result in the generation of event data (e.g., crash event data) usable for diagnosing and analyzing the crash event to determine a root cause of the crash event.

Crash event data may include features that identify and describe the crash event. The features may include: an identifier of the application; an exception category (e.g., managed, unmanaged); an exception type (e.g., defined by the application to assist in locating the machine-readable instructions of the application associated with the exception); a stack trace (e.g., data regarding operations performed by the application prior to the crash event); a version of the application; an operating system of the computing device (e.g., WINDOWS®, ANDROID®, MAC OS®); an identifier of the computing device; an enterprise (e.g., business, company) to which the computing device belongs; or other relevant information that may assist in diagnosing, analyzing, or resolving the failure. For the previous example in which the application attempted to utilize more memory than available, the features of the crash event data may include an exception category of managed; an exception type indicating memory access; and a stack trace comprising a list of machine-readable instructions executing immediately prior to the failure and data utilized by the list of machine-readable instructions, for example.

A computing device may include multiple hardware components and multiple applications. Event data may be generated by any of the hardware components or applications. As a result, hundreds or thousands of events may be generated daily. Sorting through the event data to determine which events are crash events may be difficult due to the quantity of events. For example, the event data may be collected once a week. To identify a crash event of the event data, the quantity of events to sort through is hundreds or thousands multiplied by seven. In another example, the computing device may be part of a system that includes other computing devices. For the system to identify a crash event of the event data, the system may need to sort through hundreds or thousands of events multiplied by the number of multiple computing devices of the system.

Instead of sorting through event data, enterprises that develop applications often rely on a user of the application to report a crash event. When the user reports the crash event, a work item (e.g., bug, incident, ticket, alert) is generated. The work item is for a developer of the application. The work item includes information about the crash event that might assist the developer in preventing the crash event from occurring in the future. However, the user of the application may fail to report the crash event. Additionally, the user may be one of many users who experience failures and do not report the crashes. The lack of user-provided reporting results in an incomplete and inaccurate representation of crash events. By utilizing a system to automatically collect the event data on a scheduled basis, sort through the event data to locate crash event data and create work items, crash events of an application may be identified and resolved without relying on end users of the application to report the crash events.

This disclosure describes various examples of a system creating identifiers for crash event work items. The system locates a crash event of crash event data. The system creates an identifier from features pertaining to the crash event. Crash events that share the same features utilized to create the identifier also share the same identifier. The identifier is compared to the identifiers for crash event work items. The work items are updated based on the comparison.

In one example in accordance with the present disclosure, a system is provided. The system comprises a network interface; a storage device comprising machine-readable instructions; and a processor coupled to the network interface, the processor to access the storage device. Execution of the machine-readable instructions causes the processor to collect crash event data; categorize crash event data by an application executing when the crash event occurred; identify a crash event corresponding to crash event data; create an identifier for the crash event; compare the identifier of the crash event to a list of work items, where each work item has an identifier; and update the list of work items based on the comparison.

In another example in accordance with the present disclosure, a non-transitory computer-readable medium is provided. The non-transitory computer-readable medium stores machine-readable instructions which when executed by a processor, cause the processor to: identify a crash event of a computing device; create an identifier for the crash event; compare the identifier to a list of work items; and update the list of work items based on the comparison.

In yet another example in accordance with the present disclosure, a method is provided. The method comprises identifying a crash event of an application of a computing device; identifying features of the crash event; creating an identifier based on the features; determining if the identifier equals an identifier of a work item in a list of work items; and updating the list of work items based on the determination.

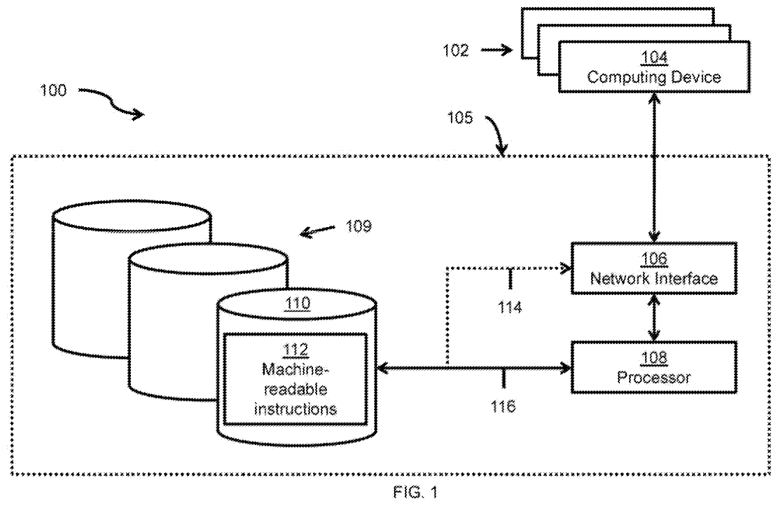

FIG. 1 depicts a schematic diagram of a system 100, in accordance with various examples. The system 100 comprises computing devices 102 and a processing environment 105 coupled to the computing devices 102. A computing device 104 of the computing devices 102 may be a laptop, notebook, tablet, smartphone, mobile device, or some other electronic device with an ability to capture data about operations of the device, for example. The processing environment 105 may be a computing device (e.g., server, central server, edge server, or some other suitable computing device) or a network of computing devices (e.g., local area network (LAN), wide area network (WAN), virtual private network (VPN), client/server network, Internet (e.g., cloud), or any other suitable system for sharing processing and memory resources).

The processing environment 105 comprises a network interface 106, a processor 108 coupled to the network interface 106, and storage devices 109. The processor 108 may be a microprocessor, a microcomputer, a microcontroller, or other suitable processor or controller, for example. In some examples, such as when the storage devices 109 are remotely managed storage devices (e.g., enterprise cloud, public cloud, data center, server, or some other suitable storage device), the processor 108 may be communicatively coupled to the storage devices 109 via a path 114 coupling the network interface 106 and the storage devices 109. In other examples, such as when the processor 108 and the storage devices 109 are located on a computing device, the storage devices 109 may be coupled via a path 116 to the processor 108. A storage device 110 of the storage devices 109 may be a hard drive, solid state drive (SSD), flash memory, random access memory (RAM), or other suitable memory, for example. The storage device 110 may store machine-readable instructions 112, which, when executed, cause the processor 108 to perform some or all of the actions attributed herein to the processor 108.

In various examples, the computing device 104 may have an identifier, while another computing device of the computing devices 102 may have another identifier. In some examples, the computing device 104 may utilize one operating system (e.g., WINDOWS®, ANDROID®, MAC OS®), while another computing device of the computing devices 102 may utilize another operating system. In other examples, the computing device 104 may belong to one enterprise, while another computing device of the computing devices 102 may belong to another enterprise. In some examples, the computing devices 102 are owned by one enterprise. Features of the crash event data such as an identifier of a computing device on which the crash event occurred, an operating system of the computing device, and an enterprise to which the computing device belongs may assist in resolving a crash event. Once the application is updated to prevent future occurrences of the crash event, the features may be usable to determine which computing devices of which enterprises should be provided an updated version of the application.

In various examples, the computing devices 102 and the system 100 belong to the same enterprise. In other examples, an enterprise owning an application installed on the computing devices 102 is also the enterprise owning the system 100. In some examples, an enterprise to which the computing devices 102 belong has granted an enterprise owning the processing environment 105 access rights to the computing devices 102. In other examples, an enterprise owning the processing environment 105 has granted an enterprise to which the computing devices 102 belong access rights to the storage devices 109. The enterprise to which the computing devices 102 belong may grant the enterprise owning the processing environment 105 access rights to data of the computing devices 102 stored on the storage devices 109. For example, the enterprise to which the computing devices 102 belong may have the ability to upload data for storage on the storage devices 109. The processing environment 105 may then access the data to identify data of interest (e.g., crash event data) and analyze the data (e.g., trends, root causes of failures). In some examples, the processing environment 105, having been granted previous access rights, may access the data automatically on a scheduled basis (e.g., daily, weekly, monthly).

In some examples, by granting access rights across multiple enterprises, an enterprise associated with the processing environment 105 may gather more crash event data of an application associated with a crash event. Having more data regarding the crash event may enable the enterprise to better prioritize the crash event. For example, if the crash event is occurring on multiple computing devices of multiple enterprises, the enterprise may assign a high priority to diagnosing, analyzing, and resolving the crash event. Additionally, more data may allow the enterprise to gather a wider variety of information to assist in diagnosing, analyzing, and resolving the crash event. For example, the enterprise may determine that the crash event is occurring on computing devices with one operating system, but that it is not occurring on computing devices having another operating system.

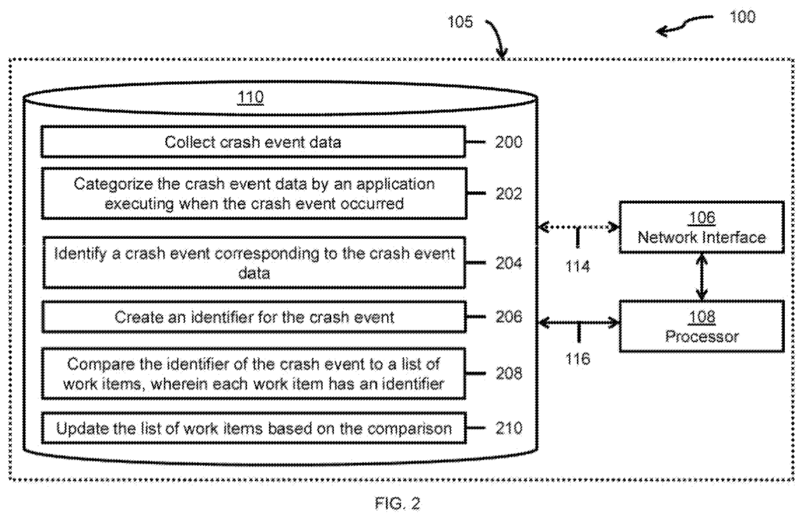

FIG. 2 depicts a schematic diagram of the processing environment 105 of the system 100, in accordance with various examples. As discussed above with respect to FIG. 1, the processing environment 105 may be a computing device or may be a network of computing devices. In one example, the processing environment 105 includes a computing device comprising the network interface 106, the storage device 110, and the processor 108. The processor 108 is coupled to the storage device 110 via the path 116 and to the network interface 106. In another example, the processing environment 105 includes a network of computing devices. A computing device comprises the network interface 106 coupled to the processor 108. The processor 108 communicatively couples to the remotely managed storage device 110 via the path 114, which couples the remotely managed storage device 110 to the network interface 106 of the computing device. In various examples, the storage device 110 may store machine-readable instructions, which, when executed, cause the processor 108 to perform some or all of the actions attributed herein to the processor 108.

In some examples, the storage device 110 comprises machine-readable instructions 200, 202, 204, 206, 208, and 210. The machine-readable instructions 200, 202, 204, 206, 208, 210 may be machine-readable instructions 112 (FIG. 1), for example. The machine-readable instructions 200, 202, 204, 206, 208, 210 may be machine-readable instructions for execution by the processor 108. The machine-readable instructions 200, 202, 204, 206, 208, 210 may cause the processor 108 to collect crash event data of a computing device (e.g., 104) and update a list of work items based on an identifier for a crash event of the crash event data. Execution of machine-readable instruction 200 may cause the processor 108 to collect crash event data. Execution of machine-readable instruction 202 may cause the processor 108 to categorize crash event data by an application executing when the crash event occurred. Execution of machine-readable instruction 204 may cause the processor 108 to identify a crash event corresponding to crash event data. Execution of machine-readable instruction 206 may cause the processor 108 to create an identifier for the crash event. Execution of machine-readable instruction 208 may cause the processor 108 to compare the identifier of the crash event to a list of work items, where each work item of the list of work items has an identifier. Execution of machine-readable instruction 210 may cause the processor 108 to update the list of work items based on the comparison.

As discussed above, an application of a computing device (e.g., 104) may fail, resulting in the creation of a crash event. The crash event may generate event data pertaining to the crash event (e.g., crash event data). In various examples, crash event data may be stored on the computing device (e.g., 104) or may be stored on a storage device (e.g., 110) within a processing environment (e.g., 105). In some examples, the processor 108 may collect crash event data from the computing device 104. In other examples, the processor 108 may collect crash event data of the computing device 104 from the storage device 110. In various examples, the processor 108 may automatically collect crash event data on a scheduled basis. For example, the processor 108 may collect crash event data every hour, daily, weekly, or on some other routine basis.

In various examples, the crash event data may be stored with event data of the computing device (e.g., 104). The processor 108 may collect the event data from the computing device 104 or from the storage device 110. The processor 108 may sort through event data and discard any event that is not crash event data. In various examples, the processor 108 may determine if event data is crash event data by examining features of the event data to determine if the event data includes an exception category. The exception category indicates a crash event associated with an application. The exception category may be managed or unmanaged. A managed exception indicates an exception generated by machine-executable instructions operating within a runtime environment. The runtime environment allows for the generation of stack traces to record operations associated with the machine-executable instructions. An unmanaged exception indicates an exception generated by machine-executable instructions executed by an operating system of a computing device. In some examples, the unmanaged exception does not generate a stack trace.

As discussed above, a computing device may include multiple applications. Each application of the multiple applications may fail and generate crash event data. Features of crash event data may include an identifier of an application that generated the crash event. The identifier of the application is usable by the processor 108 to categorize crash event data by the application responsible for the crash. In various examples, the processor 108 may aggregate crash event data of an application by sorting crash event data having the same identifier of an application into a data structure (e.g., lookup table, database). The data structure may be stored on storage device 110 or another storage device of the storage devices 109, for example. The processor 108 may aggregate crash event data of each application having an identifier in crash event data of multiple applications. The processor 108 may identify a crash event corresponding to the crash event data of a data structure pertaining to an identifier of an application. In other examples, the processor 108 may not aggregate crash event data by an application prior to identifying a crash event corresponding to the crash event data.

As discussed above, crash event data may include features usable for analyzing the failure. The features may include an identifier of an application, an exception category, an exception type, a stack trace, a version of the application, an operating system of the application, an identifier of the computing device, an enterprise to which the computing device belongs, or other relevant information that may assist in analyzing the failure. The processor 108 may create an identifier for the crash event by utilizing a subset of the features of the crash event data. For example, the processor 108 may utilize a hashing function to generate an identifier of the crash event data. In one example, such as when the exception category is managed, the exception type and the stack trace may be combined into a string variable. The string variable may be an input into the hashing function. The output of the hashing function is the identifier of the crash event. In another example, such as when the exception category is unmanaged, the exception type and the version of the application may be combined into a string variable for input into the hashing function.

In some examples, the list of work items is a list of identifiers associated with work items stored in a data structure (e.g., lookup table, database) comprising work items. The data structure may be stored on the storage device 110 or on another storage device of the storage devices 109, for example. The processor 108 searches the list of work items to determine if the identifier of the crash event matches an identifier of a work item in the list of work items (e.g., machine-readable instruction 208).

In various examples, updating the list of work items includes both the creation of a new work item as well as the modification of an existing work item. If the identifier of the crash event does not exist in the list of work items, then a new work item is created and the list is updated to include the new work item. In some examples, the creation of a new work item adds the new work item to the data structure of work items. The creation of the new work item stores the features of the crash event in a data structure of the new work item. For example, the new work item has the identifier of the crash event as an identifier of the work item and may also have an identifier of an application that generated the crash event; an exception category; an exception type; a stack trace; a version of the application; an operating system of the application; an identifier of the computing device; and an enterprise to which the computing device belongs. In some examples, the creation of the new work item stores a subset of the features of the crash event. For example, the new work item may include either a version of the application or an operating system of the application. In another example, such as when the exception category is unmanaged, the new work item may not include the stack trace.

In various examples, if the identifier of the crash event does exist in the list of work items, then a work item associated with the identifier is modified. In some examples, the modification of an existing work item may not include storing the features of the crash event in the data structure of the existing work item. Instead, subset of features may be updated to reflect an increase in a number of occurrences of the crash event since a last update, an increase in a number of devices affected by the crash event since the last update, an increase in a number of crashes per device since the last update, or changing a flag to indicate that the work item has been updated. The last update is determined by when the work item was created or modified, whichever event is more recent in time.

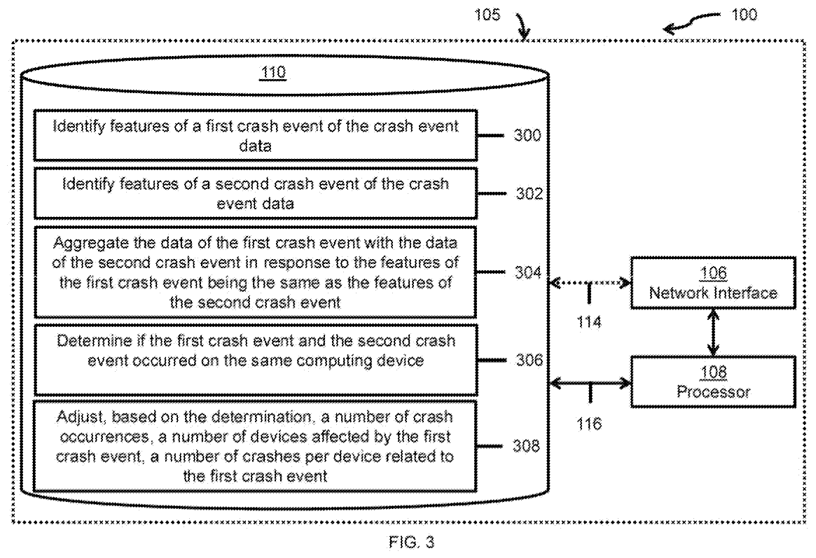

FIG. 3 depicts a schematic diagram of the processing environment 105 of the system 100, in accordance with various examples. As discussed above with respect to FIG. 1 and FIG. 2, the processing environment 105 may be a computing device comprising the network interface 106, the storage device 110, and the processor 108. The processor 108 is coupled to the storage device 110 via the path 116 and to the network interface 106. In other examples, the processing environment 105 may be a network of computing devices with a computing device of the network comprising the processor 108 coupled to the network interface 106. The processor 108 is communicatively coupled to the remotely managed storage device 110 via the path 114 coupling the remotely managed storage device 110 and the network interface 106. In various examples, the storage device 110 may store machine-readable instructions, which, when executed, cause the processor 108 to perform some or all of the actions attributed herein to the processor 108.

In some examples, the storage device 110 comprises machine-readable instructions 300, 302, 304, 306, and 308. The machine-readable instructions 300, 302, 304, 306, 308 may be machine-readable instructions 112, for example. The machine-readable instructions 300, 302, 304, 306, 308 may be machine-readable instructions for execution by the processor 108. Execution of the machine-readable instructions 300, 302, 304, 306, 308 may cause the processor 108 to aggregate crash events having a same feature and to adjust a count associated with the crash event. Execution of machine-readable instruction 300 may cause the processor 108 to identify features of a first crash event of the crash event data. Execution of machine-readable instruction 302 may cause the processor 108 to identify features of a second crash event of the crash event data. Execution of machine-readable instruction 304 may cause the processor 108 to aggregate the data of the first crash event with the data of the second crash event in response to the features of the first crash event being the same as the features of the second crash event. Execution of machine-readable instruction 306 may cause the processor 108 to determine if the first crash event and the second crash event occurred on the same computing device. Execution of machine-readable instruction 308 may cause the processor 108 to adjust, based on the determination, a number of crash occurrences, a number of devices affected by the first crash event, and/or a number of crashes per device related to the first crash event.

As discussed above with respect to FIG. 2, in various examples, the processor 108 may aggregate crash event data of an application by sorting through the crash event data and compiling into a data structure crash event data having a same identifier of an application. The processor 108 may aggregate crash event data of each application having an identifier in the crash event data of multiple applications. The processor 108 may identify features of a first crash event of the crash event data of a list of crash events for an application. The processor 108 may identify features of a second crash event of the crash event data of a list of crash events for an application.

In various examples, the processor 108 may compare a subset of the features of the first crash event to a subset of the features of the second crash event to determine if the subsets of features are the same. For example, the processor 108 may compare the exception category, the exception type, and the stack trace of the first crash event to the exception category, the exception type, and the stack trace of the second crash event. In another example, the processor 108 may compare the exception category, the exception type, and the version of the application of the first crash event to the exception category, the exception type, and the version of the application of the second crash event. If the subset of features for the first crash event equals the subset of features for the second crash event, the processor 108 may aggregate the data (e.g., machine-readable instruction 304).

Aggregating the data may include updating a list of identifiers of computing devices affected by the first crash event. For example, if there is not a list of identifiers of computing devices affected by the first crash event, the processor 108 may create the list of identifiers and store the identifier of the computing device of the first crash event. In some examples, the crash event data of the first crash event may be linked to the identifier of the computing device of the first crash event, such that if a user selected the link the crash event data is accessible. The list of identifiers of computing devices affected by the first crash event may be stored on the storage device 110 or on another storage device of the storage devices 109, for example. In some examples, the list of identifiers of computing devices affected by the first crash event may be included in the data structure of a work item having the identifier of the first crash event. In another example, if the list of identifiers of computing devices affected by the first crash event does exist, then the identifier of the computing device associated with second crash event may be compared to each identifier of the list of computing devices to determine if the computing device of the second crash event is on the list. If the computing device is not on the list, the list may be modified to include the identifier of the computing device of the second crash event. In some examples, the crash event data of the second crash event may be linked to the identifier of the computing device. Linking the crash event data to the identifier of the computing device may provide a developer of the application associated with the crash event access to some or all of the features of the crash event on the computing device.

As discussed above with respect to FIG. 2, the processor 108 may collect data from multiple computing devices (e.g., computing devices 102). Crash event data from a first computing device (e.g., computing device 104) may have as a feature an identifier of the first computing device. Crash event data from a second computing device may have as a feature an identifier of the second computing device. The processor 108 may compare the identifier of a computing device associated with the first crash event to the identifier of a computing device associated with the second crash event. If the identifiers are not the same, then the processor 108 may increase a number of devices affected by the first crash event and a number of crash occurrences. If the identifiers are the same, then the processor 108 may increase a number of crash occurrences and a number of crashes per the first computing device.

In one example, a first crash event has as a feature an identifier of a first computing device. A second crash event has as a feature an identifier of a second computing device. A list of identifiers of computing devices affected by the first crash event includes the identifier of the second computing device. The processor 108 may increase the number of crash occurrences as well as the number of crashes per the second computing device. In another example, the list of identifiers of a computing device affected by the first crash does not include the identifier of the second computing device. The processor 108 may increase the number of crash occurrences, increase the number of devices affected by the first crash event, increase the number of crashes associated with the second computing device, and add the identifier of the second computing device to the list of computing devices affected by the first crash event. In some examples, the list of identifiers of a computing device affected by the first crash, the number of crash occurrences, the number of devices affected by the first crash event, and the number of crashes associated with each computing device in the list of computing devices may be stored in the data structure of the work item sharing an identifier with the first crash event.

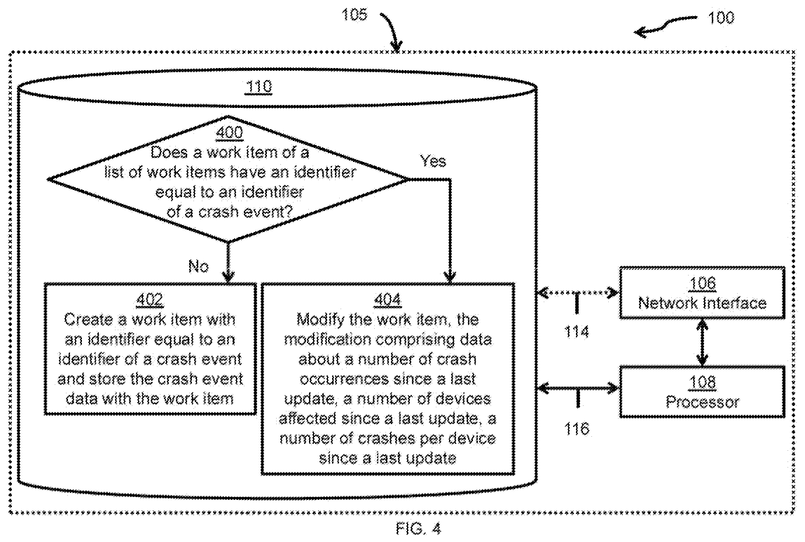

FIG. 4 depicts a schematic diagram of the processing environment 105 of the system 100, in accordance with various examples. As discussed above with respect to FIG. 1, FIG. 2, and FIG. 3, the processing environment 105 may be a computing device comprising the network interface 106, the storage device 110, and the processor 108. The processor 108 coupled to the storage device 110 via the path 116 and to the network interface 106. In other examples, the processing environment 105 may be a network of computing devices with a computing device of the network comprising the processor 108 coupled to the network interface 106. The processor 108 is communicatively coupled to the remotely managed storage device 110 via the path 114 coupling the remotely managed storage device 110 and the network interface 106. In various examples, the storage device 110 may store machine-readable instructions, which, when executed, cause the processor 108 to perform some or all of the actions attributed herein to the processor 108.

In some examples, the storage device 110 comprises machine-readable instructions 400, 402, and 404. The machine-readable instructions 400, 402, 404 may be machine-readable instructions 112, for example. The machine-readable instructions 400, 402, 404 may be machine-readable instructions for execution by the processor 108. Execution of the machine-readable instructions 400, 402, 404 may cause the processor 108 to update a list of work items based on a comparison of an identifier of a work item of the list of work items and an identifier of a crash event. Execution of machine-readable instruction 400 may cause the processor 108 to determine if the work item of the list of work items has an identifier equal to the identifier of the crash event. Execution of machine-readable instruction 402 may cause the processor 108 to create a work item with an identifier equal to the identifier of the crash event and store the crash event data with the work item. Execution of machine-readable instruction 404 may cause the processor 108 to modify the work item, the modification comprising data about a number of crash occurrences since a last update, a number of devices affected since a last update, and/or a number of crashes per device since a last update.

As discussed above with respect to FIG. 2, in some examples, in response to the processor 108 determining that a work item of a list of work items does have an identifier equal to an identifier of a crash event, the processor 108 updates the list of work items by modifying the work item. (See discussion above with respect to FIG. 2 and FIG. 3 for examples.) In other examples, in response to the processor 108 determining that a work item of the list of work items does not have an identifier equal to an identifier of a crash event, the processor updates the list of work items by creating a work item with an identifier equal to an identifier of the crash event and storing the crash event data with the work item. (See discussion above with respect to FIG. 2 for examples.)

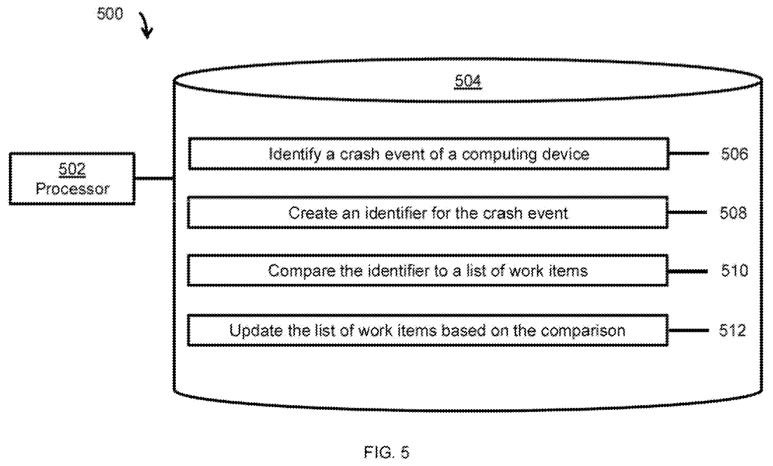

FIG. 5 depicts a schematic diagram of a system 500, in accordance with various examples. The system 500 comprises a computer-readable medium 504 and a processor 502 coupled to the computer-readable medium 504. The system 500 may be the processing environment 105, for example. The system 500 may be a computing device or a network of computing devices, as discussed above with respect to FIG. 1. The computer-readable medium 504 may be a storage device such as a hard drive, solid state drive (SSD), flash memory, random access memory (RAM), or other suitable memory, for example. The computer-readable medium 504 may be the storage device 110, for example. The computer-readable medium 504 may be local to the computing device or may be on a remotely managed storage device (e.g., enterprise cloud, public cloud, data center, server, or some other suitable storage device), as discussed above with respect to FIG. 1. The processor 502 may be a microprocessor, a microcomputer, a microcontroller, or another suitable embedded processor or embedded controller, for example. The processor 502 may be the processor 108, for example. The processor 502 may be local to the computing device comprising the computer-readable medium 504 or may be on a remotely managed computing device, as discussed above with respect to FIG. 1. The computer-readable medium 504 may store machine-readable instructions, which, when executed, cause the processor 502 to perform some or all of the actions attributed herein to the processor 502.

The computer-readable medium 504 comprises machine-readable instructions 506, 508, 510, and 512. The machine-readable instructions 506, 508, 510, 512 may be machine-readable instructions 112, for example. The machine-readable instructions 506, 508, 510, 512 may be machine-readable instructions for execution by the processor 502. Execution of the machine-readable instructions 506, 508, 510, 512 may cause the processor 502 to identify a crash event and update a list of work items based on an identifier of the crash event. Execution of machine-readable instruction 506 may cause the processor 502 to identify a crash event of a computing device (e.g., computing device 104). Execution of machine-readable instruction 508 may cause the processor 502 to create an identifier for the crash event. Execution of machine-readable instruction 510 may cause the processor 502 to compare the identifier to a list of work items. Execution of instruction 512 may cause the processor 502 to update the list of work items based on the comparison.

As discussed above, an application of a computing device (e.g., 104) may fail, resulting in the creation of a crash event. The crash event may generate event data pertaining to the crash event (e.g., crash event data). As discussed above with respect to FIG. 2, in various examples, the crash event data may be stored with event data of the computing device. The processor 502 may collect the event data from a storage device of the computing device or from the storage devices of a processing environment (e.g., 105). In various examples, the processor 502 may automatically collect crash event data on a scheduled basis. For example, the processor 108 may collect crash event data every hour, daily, weekly, or on some other routine basis. The processor 502 may sort through event data and discard any event that is not crash event data. In various examples, the processor 502 may determine if event data is crash event data by searching for the exception category of the crash event data.

In some examples, the processor 502 may collect crash event data from multiple computing devices. However, the processor 502 may be tasked with diagnosing, analyzing, and resolving a crash event of distinct computing devices. For example, the processor 502 may be tasked with diagnosing, analyzing, and resolving a crash event of an application utilized by an enterprise. The processor 502 may search for the identifier of a computing device feature of the crash event data to locate computing devices belonging to the enterprise.

In some examples, the processor 502 may create an identifier for the crash event by utilizing a subset of the features of the crash event data. (See discussion above with respect to FIG. 2 for an example.) For examples in which the processor 502 is tasked with diagnosing, analyzing, and resolving a crash event of distinct computing devices, the processor 502 may include an identifier of a computing device associated with the crash event when creating the identifier for the crash event. The processor 502 may compare the identifier for the crash event to identifiers of work items in a list of work items. The processor 502 may update the list of work items based on the comparison. (See discussion above with respect to FIG. 2 for an example.)

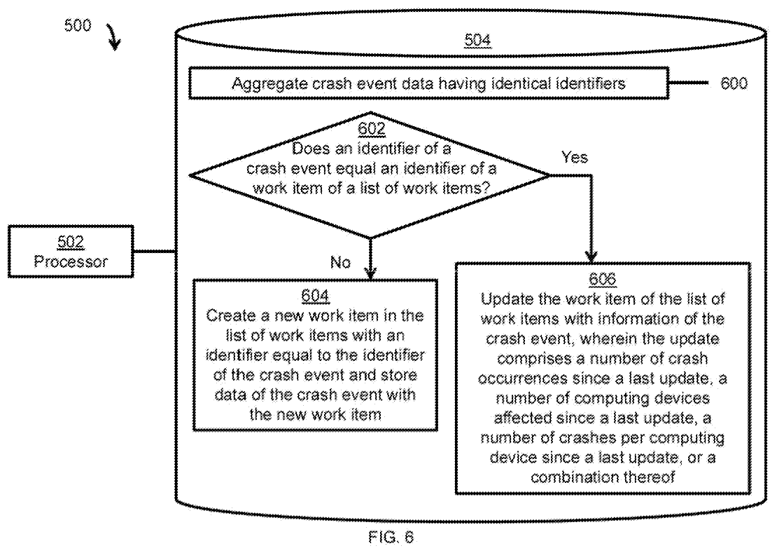

FIG. 6 depicts a schematic diagram of the system 500, in accordance with various examples. As discussed above with respect to FIG. 5, the system 500 comprises the computer-readable medium 504 and the processor 502 coupled to the computer-readable medium 504. The system 500 may be the processing environment 105, for example. The computer-readable medium 504 may be the storage device 110, for example. The processor 502 may be the processor 108, for example.

In some examples, the computer-readable medium 504 may comprise machine-readable instructions 600, 602, 604, and 606. The machine-readable instructions 600, 602, 604, 606 may be machine-readable instructions 112, for example. The machine-readable instructions 600, 602, 604, 606 may be machine-readable instructions for execution by the processor 502. Execution of the machine-readable instructions 600, 602, 604, 606 may cause the processor 502 to aggregate crash event data having the same identifier and update a list of work items with the aggregated crash event data. Execution of machine-readable instruction 600 may cause the processor 502 to aggregate crash event data having the same identifier. Execution of machine-readable instruction 602 may cause the processor 502 to determine if an identifier of a crash event equals an identifier of a work item of a list of work items. Execution of machine-readable instruction 604 may cause the processor 502 to create a new work item in the list of work items with an identifier equal to the identifier of the crash event and store data of the crash event with the new work item. Execution of machine-readable instruction 606 may cause the processor 502 to update the work item of the list of work items with information of the crash event, where the update comprises a number of crash occurrences since a last update, a number of computing devices affected since a last update, a number of crashes per computing device since a last update, or a combination thereof.

In various examples, such as when processing a large batch of crash event data, the processor 502 may create an identifier for the crash event utilizing a subset of features, such as the exception category, the exception type, and the stack trace. The processor 502 may create an identifier for each crash event of the crash event data. The processor 502 may aggregate crash events having a same identifier into a list. The processor 502 may set a number of crash occurrences for the list equal to the number of crash events in the list. Utilizing the identifier of the computing device feature of the crash event data, the processor 502 may create a list of computing devices affected by the crash events having a same identifier. Each distinct identifier of a computing device is listed and a number of crashes per device is incremented for each crash event having the identifier of the computing device. A number of devices affected by the crash event equals the number of distinct identifiers of a computing device in the list. The processor 502 may compare the identifier of the crash event with the identifiers of a list of work items. If the identifier of the crash event is not in the list of work items, the processor 502 may create a new work item having the identifier of the crash event and amend to the new work item the list of computing devices affected by the crash event, the number of crashes per device, the number of devices affected by the crash event, and the total number of occurrences. If the identifier of the crash event is in the list of work items, then the processor 502 may aggregate the existing work item list of computing devices affected by the crash event with the most recent list of computing devices affected by the crash event. The processor 502 may update the number of crashes per device, the number of devices affected by the crash event, and the total number of occurrences of the existing work item to include the most recent numbers. The processor 502 may flag the existing work item to indicate the work item has been updated.

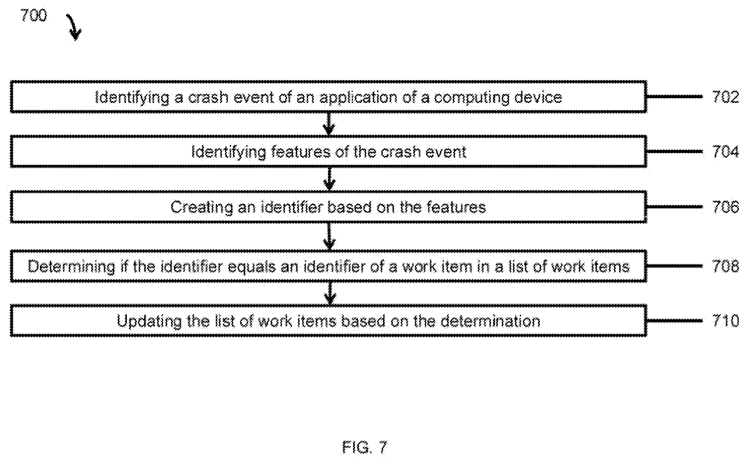

FIG. 7 depicts a flow diagram of a method 700, in accordance with various examples. The method 700 may be performed, for instance, by the processor 108, 502. The method includes identifying a crash event of an application of a computing device (702). The method also includes identifying features of the crash event (704). In addition, the method includes creating an identifier based on the features (706). Additionally, the method includes determining if the identifier equals an identifier of a work item in a list of work items (708). The method also includes updating the list of work items based on the determination (710).

As discussed above with respect to FIG. 5, the processor 502 may collect event data from a storage device of the computing device or from the storage devices of a processing environment (e.g., 105). The processor 502 may sort through event data and discard any event that is not crash event data. In various examples, the processor 502 may determine if event data is crash event data by searching for the exception category of the crash event data. In some examples, the processor 502 may create an identifier for the crash event by utilizing a subset of the features of the crash event data. (See discussion above with respect to FIG. 2 for an example.) For examples in which the processor 502 is tasked with diagnosing, analyzing, and resolving a crash event of a distinct application, the processor 502 may include an identifier of an application associated with the crash event when creating the identifier for the crash event. The processor 502 may determine if the identifier for the crash event equals an identifier of a work item in a list of work items. The processor 502 may update the list of work items based on the determination. (See discussion above with respect to FIG. 2 for an example.)

In other examples, such as when processing a large batch of crash event data, the processor 502 may create an identifier for the crash event utilizing a subset of features, such as identifier of an application, exception category, the exception type, stack trace. The processor 502 may create an identifier for each crash event of the crash event data. As discussed with respect to FIG. 6 above, the processor 502 may aggregate crash events having a same identifier, determine if an identifier of a crash event equals an identifier of a work item in a list of work items, and update the list of work items based on the determination.

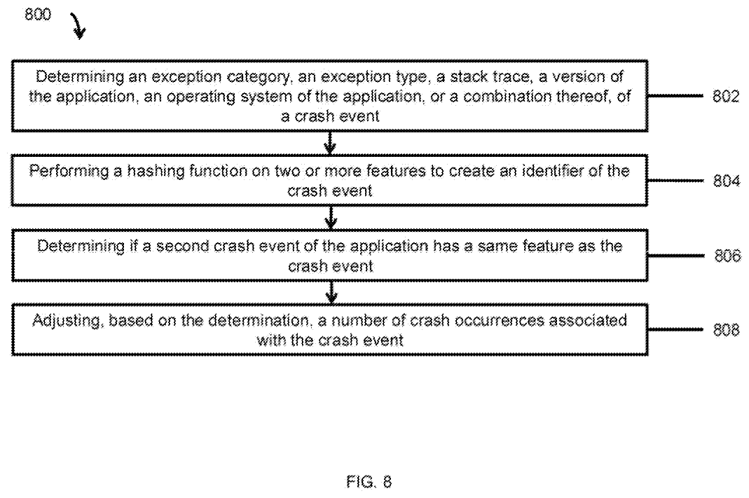

FIG. 8 depicts a flow diagram of a method 800, in accordance with various examples. The method 800 may be performed, for instance, by the processor 108, 502. The method includes determining an exception category, an exception type, a stack trace, a version of the application, an operating system of the application, or a combination thereof, of a crash event (802). The method also includes utilizing a hashing function on two or more features to create an identifier of the crash event (804). (See discussion above with respect to FIG. 2 for an example.) In addition, the method includes determining if a second crash event of the application has a same feature as the crash event (806). Additionally, the method includes adjusting, based on the determination, a number of crash occurrences associated with the crash event (808). (See discussion above with respect to FIG. 3 for an example.)

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, for clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value. As used herein, the term “computing device,” refers to an electronic device that is to carry out machine readable instructions, and may include internal components, such as, processors, power sources, memory devices, etc. For example, a computing device may include, among other things, a personal computer, a smart phone, a tablet computer, a laptop computer, a personal data assistant, etc.

What is claimed is:

1. A system comprising:
a network interface;
a storage device comprising machine-readable instructions; and
a processor coupled to the network interface, the processor to access the storage device, wherein execution of the machine-readable instructions causes the processor to:
collect crash event data;
categorize the crash event data by an application executing when the crash event occurred;
identify a crash event corresponding to the crash event data;
create an identifier for the crash event;
compare the identifier of the crash event to a list of work items, wherein each work item has an identifier; and
update the list of work items based on the comparison.

2. The system of claim 1, wherein execution of the machine-readable instructions causes the processor to:
identify features of a first crash event of the crash event data;
identify features of a second crash event of the crash event data; and
aggregate the data of the first crash event with the data of the second crash event in response to the features of the first crash event being the same as the features of the second crash event.

3. The system of claim 2, wherein execution of the machine-readable instructions cause the processor to collect crash event data automatically on a scheduled basis.

4. The system of claim 2, wherein execution of the machine-readable instructions causes the processor to:
determine if the first crash event and the second crash event occurred on a single computing device; and
adjust, based on the determination, a number of crash occurrences, a number of devices affected by the first crash event, and a number of crashes per device related to the first crash event.

5. The system of claim 1, wherein execution of the machine-readable instructions causes the processor to modify a work item of the list of work items having an identifier equal to the identifier of the crash event, the modification comprising data about a number of crash occurrences since a last update, a number of devices affected since a last update, a number of crashes per device since a last update, or a combination thereof.

6. The system of claim 1, wherein execution of the machine-readable instructions causes the processor to update the list of work items by creating a work item with an identifier equal to the identifier of the crash event and storing the crash event data with the work item.

7. A non-transitory computer-readable medium storing machine-readable instructions which when executed by a processor, cause the processor to:
identify a crash event of a computing device;
create an identifier for the crash event;
compare the identifier to a list of work items; and
update the list of work items based on the comparison.

8. The computer-readable medium of claim 7, wherein execution of the machine-readable instructions causes the processor to create the identifier based on a feature of the crash event, wherein the feature is selected from an application, an exception category, an exception type, a stack trace, a version of the application, an operating system of the application, or a combination thereof.

9. The computer-readable medium of claim 8, wherein execution of the machine-readable instructions causes the processor to aggregate crash event data having identical identifiers.

10. The computer-readable medium of claim 7, wherein execution of the machine-readable instructions causes the processor to update a work item of the list of work items with information of the crash event in response to the comparison indicating that the identifier equals an identifier of the work item, wherein the update comprises a number of crash occurrences since a last update, a number of computing devices affected since a last update, a number of crashes per computing device since a last update, or a combination thereof.

11. The computer-readable medium of claim 7, wherein execution of the machine-readable instructions causes the processor to create a new work item in the list of work items with an identifier equal to the identifier of the crash event and to store data of the crash event with the new work item in response to the comparison indicating the identifier does not equal an identifier of a work item of the list of work items.

12. A method comprising:
identifying a crash event of an application of a computing device;
identifying features of the crash event;
creating an identifier based on the features;
determining if the identifier equals an identifier of a work item in a list of work items; and
updating the list of work items based on the determination.

13. The method of claim 12, wherein identifying a crash event comprises aggregating crash events with the same features by:
determining if a second crash event of the application has a same feature as the crash event; and
adjusting, based on the determination, a number of crash occurrences associated with the crash event.

14. The method of claim 12, wherein identifying features of the crash event comprises determining an exception category, an exception type, a stack trace, a version of the application, an operating system of the application, or a combination thereof.

15. The method of claim 12, wherein creating an identifier comprises utilizing a hashing function on two or more of the features.
